(19) United States
(12) Patent Application Publication
(10) Pub. No.: US 2019/0277595 A1
(43) Pub. Date: Sep. 12, 2019

(54) Shooting rest

(71) Applicant: Jimmy Dwayne Oetken, Houston, TX (US)

(72) Inventor: Jimmy Dwayne Oetken, Houston, TX (US)

(21) Appl. No.: 16/501,193

(22) Filed: Mar. 5, 2019

Related U.S. Application Data
(60) Provisional application No. 62/761,016, filed on Mar. 7, 2018.

(51) Int. Cl. F41A 23/16

(52) U.S. Cl. CPC F41A 23/16; A01M 31/025

(57) ABSTRACT

An shooting rest having an adjustable length beam terminating at each end of the beam with an angle bracket so that the length of the shooting rest can be adjusted so that the angle brackets rest on a frame section or window ledge of a shooting blind so that a hunter positioned in the hunting blind can use the adjustable length beam as a shooting rest.

### BACKGROUND OF THE INVENTION

The instant invention relates to shooting rests used by hunters. A hunter shooting from a hunting blind with a rifle often has difficulty holding the rifle steady when shooting at a game animal. In an attempt to solve this problem, some hunters attach each end of a board to a frame structure of the blind across the interior of the blind and use the board as a shooting rest. The problem with this approach is that the shooting rest is often too high. Hunters have discovered a number of advances in the art of shooting rests for use in a hunting blind. For example U.S. Pat. No. 8,756,872 disclosed a hunting blind having an armrest positioned below the window of the blind; and U.S. Pat. No. 9,163,893 disclosed an adjustable shooting rest for use in a hunting blind. Despite the many advances in this art, there remains a need for a shooting rest for use in a hunting blind that is less complicated and provides improved utility over prior art shooting rests.

### SUMMARY OF THE INVENTION

The instant invention is the discovery of a shooting rest, comprising: (a) a first beam section having a first end, a second end and a longitudinal axis, the first beam section being hollow along said longitudinal axis from said second end toward said first end so that the first beam section comprises a hollow portion along said longitudinal axis from said second end toward said first end; (b) a second beam section having a first end, a second end and a longitudinal axis, the first end of the second beam section being slideably inserted into the hollow portion of the first beam section, the longitudinal axis of the first beam section being essentially coincident with the longitudinal axis of the second beam section; (c) a first angle bracket having a first leg and a second leg, the first leg of the first angle bracket attached to or formed integrally with the first end of the first beam section, the second leg of the first angle bracket having a longitudinal axis, the longitudinal axis of the second leg of the first angle bracket being spaced apart from the longitudinal axis of the first beam section; and (d) a second angle bracket having a first leg and a second leg, the first leg of the second angle bracket attached to or formed integrally with the second end of the second beam section, the second leg of the second angle bracket having a longitudinal axis, the longitudinal axis of the second leg of the second angle bracket being spaced apart from the longitudinal axis of the second beam section in essentially the same direction as the longitudinal axis of the second leg of the first angle bracket is spaced apart from the longitudinal axis of the first beam section.

### BRIEF DESCRIPTION OF THE DRAWINGS

FIG. 1 is a side view of a highly preferred embodiment of the instant invention; and

FIG. 2 is a drawing showing a hunter in a hunting blind using the instant invention.

### DETAILED DESCRIPTION OF THE INVENTION

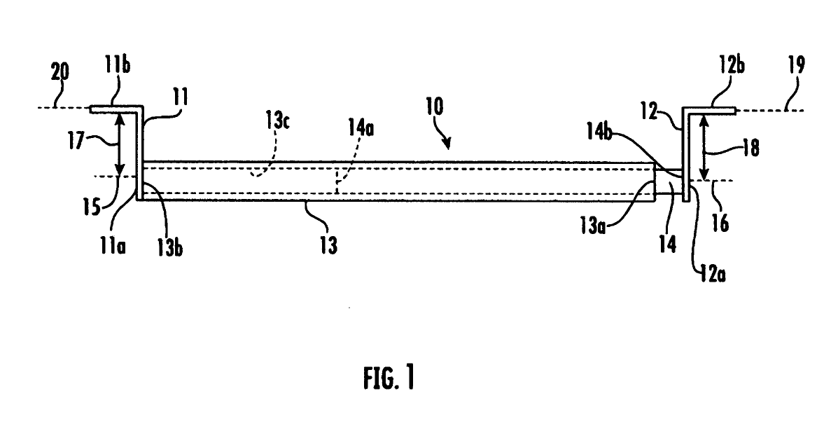

Referring now to FIG. 1, therein is shown a side view of a highly preferred embodiment 10 of the instant invention. Shooting rest 10 comprises first beam section 13 having first end 13a, second end 13b and longitudinal axis 15. First, beam section 13 is hollow along longitudinal axis 15 from first end 13a toward second end 13b so that first beam section 13 comprises hollow portion 13c along longitudinal axis 15 from said first end 13a toward said second end 13b. Shooting rest 10 also comprises second beam section 14 having first end 14a, second end 14b and longitudinal axis 16. First end 14a of second beam section 14 is slideably inserted into hollow portion 13c of first beam section 13, the longitudinal axis 15 of first beam section 13 being essentially coincident with longitudinal axis 16 of second beam section 14. Shooting rest 10 further comprises first angle bracket 11 having first leg 11a and second leg 11b. First leg 11a of first angle bracket 11 is attached to or formed integrally with second end 13b of first beam section 13. Second leg 11b of first angle bracket 11 having longitudinal axis 20. Longitudinal axis 20 of second leg 11b of first angle bracket 11 being spaced apart distance 17 from longitudinal axis 15 of first beam section 13. Shooting rest 10 also comprises second angle bracket 12 having first leg 12a and second leg 12b. First leg 12a of second angle bracket 12 is attached to or formed integrally with second end 14b of second beam section 14. Second leg 12b of second angle bracket 12 having longitudinal axis 19. Longitudinal axis 19 of second leg 12b of second angle bracket 12 being spaced apart distance 18 from longitudinal axis 16 of second beam section 14 in essentially the same direction as longitudinal axis 20 of second leg 11b of the first angle bracket 11 is spaced apart longitudinal axis 15 of first beam section 13.

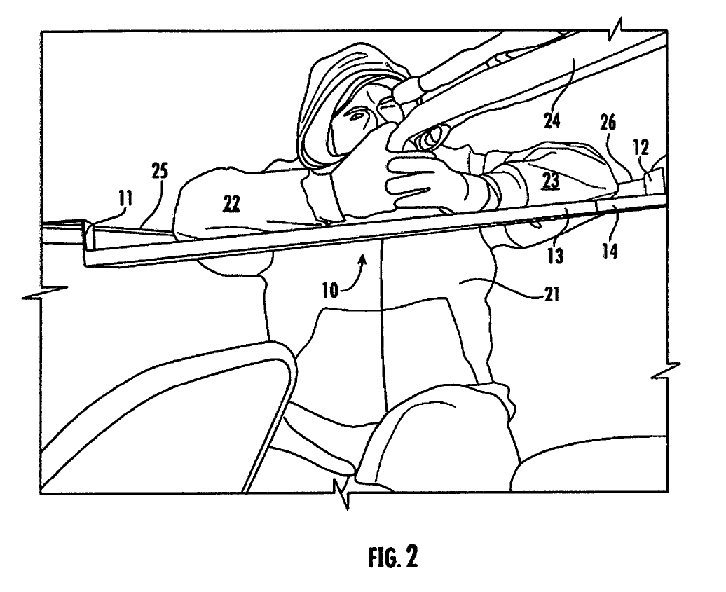

In use the length of the beam formed by beam sections 13 and 14 is adjusted so that legs 11a and 12a are supported by a structure of a hunting blind so that the beam can be used as a shooting rest as depicted for example in FIG. 2 which shows embodiment 10 being used by hunter 21 as a shooting rest in a hunting blind. The legs of angle brackets 11 and 12 are shown supported by frame elements 25 and 26 of a hunting blind so that arms 22 and 23 of hunter 21 can be rested on beam sections 13 and 14 to steady the aim of rifle 24.

The components of the instant invention can be made of any suitable material such as and without limitation thereto, steel, aluminum, plastic or wood or any combination thereof. The brackets at the end of the beam sections can be attached to the ends of the beam sections or integrally formed with the beam sections. A highly preferred shooting rest according to the instant invention for use in a box blind would be 36 inches long at its shortest length and telescoping to 60 inches long at its longest length. It would have a 2″ drop (shown as dimensions 17 and 18 in FIG. 1) on each end of the beam sections. In use the legs of the angle brackets rest on a rod or frame element or window ledge or shelf of the box blind. When shooting from a window of a box blind with a simple board shooting rest placed on the edge of the window, the shooters elbow or elbows can be awkwardly positioned at too high a level. The lowered position of the beam of the instant invention allows the shooter to lower his/her arms while shooting to better stabilize one or both of the shooter's arms and elbows.

Referring again to FIG. 1, beam section 13 can be made out of 1″×2″×36″ 16 gauge rectangular metal tubing while beam section 14 can be a 1 and 13/16″× 13/16″×34″ solid oak insert. Angle brackets 11 and 12 can be formed from 14 gauge 1⅞″×5½″ metal strips that are bent to form arms at 90 degrees . . . . Bracket 11 can be welded to beam section 13. Bracket 12 can be attached to oak beam section 14 (if beam sections 14 is oak) by screws or lag bolts.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains.

What is claimed is:

1. A shooting rest, comprising:
(a) a first beam section having a first end, a second end and a longitudinal axis, the first beam section being hollow along said longitudinal axis from said first end toward said second end so that the first beam section comprises a hollow portion along said longitudinal axis from said first end toward said second end;
(b) a second beam section having a first end, a second end and a longitudinal axis, the first end of the second beam section being slideably insertable into the hollow portion of the first beam section, the longitudinal axis of the first beam section being essentially coincident with the longitudinal axis of the second beam section;
(c) a first angle bracket having a first leg and a second leg, the first leg of the first angle bracket attached to or formed integrally with the second end of the first beam section, the second leg of the first angle bracket having a longitudinal axis, the longitudinal axis of the second leg of the first angle bracket being spaced apart from the longitudinal axis of the first beam section; and
(d) a second angle bracket having a first leg and a second leg, the first leg of the second angle bracket attached to or formed integrally with the second end of the second beam section, the second leg of the second angle bracket having a longitudinal axis, the longitudinal axis of the second leg of the second angle bracket being spaced apart from the longitudinal axis of the second beam section in essentially the same direction as the longitudinal axis of the second leg of the first angle bracket is spaced apart from the longitudinal axis of the first beam section.

2. A method for a hunter to shoot at game animals from a box blind using a rifle, the box blind having one or more interior support elements such as a shelf, a window ledge, a support rod, and a frame, comprising:
(a) resting the second leg of the first angle bracket of the shooting rest of claim 1 on a support element of the blind;
(b) resting the second leg of the second angle bracket of the shooting rest of claim 1 on another support element of the blind so that the first and second beam sections of the shooting rest of claim 1 can be used by the hunter to steady the aim of the rifle by resting the arms of the hunter on the first and second beam sections of the shooting rest of claim 1 when the hunter is holding the rifle in the hands of the hunter to sight the rifle.
